(19) United States
(12) Patent Application Publication
(10) Pub. No.: US 2025/0157257 A1
(43) Pub. Date: May 15, 2025

(54) METHOD AND DEVICE FOR EXTRACTING CONTEXT RELATED TO A PERSON FROM A VIDEO

(71) Applicant: Electronics and Telecommunications Research Institute, Daejeon (KR)

(72) Inventor: Ji Youn LIM, Daejeon (KR)

(73) Assignee: Electronics and Telecommunications Research Institute, Daejeon (KR)

(21) Appl. No.: 18/945,654

(22) Filed: Nov. 13, 2024

(30) Foreign Application Priority Data
Nov. 13, 2023 (KR) 10-2023-0156467

(51) Int. Cl. G06V 40/20; G06V 10/74; G06V 10/762; G06V 10/764; G06V 10/77; G06V 20/40; G06V 20/64

(52) U.S. Cl. CPC G06V 40/20; G06V 10/761; G06V 10/7635; G06V 10/764; G06V 10/7715; G06V 20/41; G06V 20/64

(57) ABSTRACT

A method and device for obtaining context associated with a character in a video are disclosed. A method for obtaining a context associated with a character in a video, performed by a device according to one embodiment of the present disclosure, may include obtaining appearance time information for at least one character appearing in a specific video; obtaining a context related to at least one character from a video portion corresponding to a time at which the at least one character appeared based on the appearance time information; generating at least one graph representing a context of the at least one character based on the context related to the at least one character; and classifying the at least one character using the at least one graph.

### CROSS-REFERENCE TO RELATED APPLICATIONS

This application claims the benefit of earlier filing date and right of priority to Korean Application No. 10-2023-0156467, filed on Nov. 13, 2023, the contents of which are all hereby incorporated by reference herein in their entirety.

### TECHNICAL FIELD

The present disclosure relates to a technology for extracting information from an image, and more specifically, to a method and device for identifying a person appearing in an image and extracting and utilizing a context associated with the identified person.

### BACKGROUND

In commercial videos (e.g., movies, dramas, and advertisements), characters play a very important role. characters appearing in a video can play an important role in revealing the theme of the video and can also determine the commercial value of the video.

Meanwhile, since video is multi-modal data consisting of image and sound data, various information can be extracted by analyzing it. Accordingly, various image processing technologies are being developed and utilized to extract various information from video.

For example, technologies for recognizing the face and movements of a character appearing in a video (e.g., technologies for defining the facial features of a person by considering the image features of a video and extracting the location of the face to identify the face) and technologies for re-identifying a character in a video shot with multiple cameras (i.e., technologies for identifying whether the same character appears in videos shot with different cameras at different times) are being widely developed and utilized.

### SUMMARY

The technical problem of the present disclosure is to provide a method and device for extracting a context associated with a person from an image (or video).

The technical problem of the present disclosure is to provide a method and device for extracting the contextual importance of a person appearing in a video through the role of the person and the interaction between the character and other characters.

The technical problems to be achieved in the present disclosure are not limited to the technical tasks mentioned above, and other technical problems not mentioned will be clearly understood by those skilled in the art from the description below.

A method of obtaining context associated with a character in a video performed by a device may include obtaining appearance time information for at least one character appearing in a specific video; obtaining a context related to at least one character from a video portion corresponding to a time at which the at least one character appeared based on the appearance time information; generating at least one graph representing a context of the at least one character based on the context related to the at least one character; and classifying the at least one character using the at least one graph.

In addition, the obtaining the appearance time information may include identifying i) an appearance start time and an appearance end time and ii) a number of appearances of the at least one character in the specific video; and obtaining an appearance time list composed of the appearance start time and the appearance end time of the at least one character as the appearance time information.

In addition, a context related to a first character among the at least one characters may include: i) information about an interaction of the first character with other objects with which the first character interacts; ii) a proportion of the first character in the specific video portion; iii) a similarity between visual-auditory features of the first character and visual-auditory features of other characters; and iv) a similarity between behavioral features of the first character and behavioral features of the other characters.

In addition, based on the similarity between the visual-auditory features of the first character and the visual-auditory features of the other characters and the similarity between the behavioral features of the first character and the behavioral features of the other characters, a three-dimensional tensor representing visual-auditory-behavioral features between the first character and the other characters may be generated.

In addition, based on the appearance time information, a three-dimensional tensor may be generated that represents the visual-auditory-behavioral features between the first character and the other characters at each time the first character appears.

In addition, a graph of the first character may include nodes corresponding to the first character, the other objects, and the other characters, respectively, based on the context related to a first character among the at least one character, nodes corresponding to each of the first character, the other objects and the other character may be connected, and nodes representing a visual feature, audio feature, and behavioral feature of the first character may be connected to the nodes corresponding to the first character.

In addition, the classifying may include classifying each of the at least one character into a specific category by performing character node clustering on the at least one graph.

In addition, the specific category may include at least one of a specific character category of the specific video, a main character category that assists the specific character of the specific video, a character category that connects characters appearing in the specific video, or a character category that has unique features in the specific video.

In addition, the method may further include identifying a graph of the first character based on a query input for the first character; identifying at least one node associated with the query among the graph of the first character; and outputting an answer to the query based on the at least one node.

As another example of the present disclosure, a device for obtaining context associated with a character in a video may include at least one memory; and at least one processor, and the at least one processor may be configured to: obtain appearance time information for at least one character appearing in a specific video; obtain a context related to at least one character from a video portion corresponding to a time at which the at least one character appeared based on the appearance time information; generate at least one graph representing a context of the at least one character based on the context related to the at least one character; and classify the at least one character using the at least one graph.

In addition, the at least one processor may be configured to: identify i) an appearance start time and an appearance end time and ii) a number of appearances of the at least one character in the specific video; and obtain an appearance time list composed of the appearance start time and the appearance end time of the at least one character as the appearance time information.

In addition, the at least one processor may be configured to: classify each of the at least one character into a specific category by performing character node clustering on the at least one graph.

In addition, the at least one processor may be configured to: identify a graph of the first character based on a query input for the first character; identify at least one node associated with the query among the graph of the first character; and output an answer to the query based on the at least one node.

In addition, according to one embodiment of the present disclosure, at least one non-transitory computer readable medium storing at least one instruction, based on the at least one instruction being executed by at least one processor, a device may control to: obtain appearance time information for at least one character appearing in a specific video; obtain a context related to at least one character from a video portion corresponding to a time at which the at least one character appeared based on the appearance time information; generate at least one graph representing a context of the at least one character based on the context related to the at least one character; and classify the at least one character using the at least one graph.

The features briefly summarized above with respect to the disclosure are merely exemplary aspects of the detailed description of the disclosure that follows, and do not limit the scope of the disclosure.

According to various embodiments of the present disclosure, a method and device for extracting context associated with a person from an image (or video) may be provided.

According to various embodiments of the present disclosure, a method and device for extracting contextual importance of a person appearing in a video through the role of the person and interaction between the character and other characters may be provided.

According to various embodiments of the present disclosure, users can perform video searches using person-centered context, thereby enabling expanded searches focused on consumer tendencies.

According to various embodiments of the present disclosure, limitations of conventional image search services can be overcome, and customized image services can be configured more efficiently.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings, which are included as part of the detailed description to aid understanding of the present disclosure, provide embodiments of the present disclosure, and together with the detailed description, explain technical features of the present disclosure.

FIG. 1 is a flowchart illustrating a method for extracting context associated with a person from an image according to one embodiment of the present disclosure.

FIG. 2 is a diagram for explaining a person-centered context extraction system and device according to one embodiment of the present disclosure.

FIG. 3 is a diagram for explaining a method for extracting appearance time information of multiple characters appearing in a video according to one embodiment of the present disclosure.

FIG. 4 is a diagram for explaining the configuration of a character context inference module according to an embodiment of the present disclosure.

FIG. 5 illustrates audio-visual feature similarity according to an embodiment of the present disclosure.

FIG. 6 illustrates a three-dimensional tensor representing audio-visual-action feature similarity according to an embodiment of the present disclosure.

FIG. 7 is a diagram for explaining a set of time-dependent similarity tensors according to an embodiment of the present disclosure.

FIG. 8 is a diagram for explaining a graph of character k and other objects at t according to an embodiment of the present disclosure.

FIG. 9 is a diagram for explaining a method for extracting a subgraph according to an embodiment of the present disclosure.

FIG. 10 is a diagram for explaining a method for performing node clustering according to an embodiment of the present disclosure.

FIG. 11 is a block diagram illustrating a device according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In the present disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as the ‘system’) proposed in the present disclosure relates to a technique for extracting a context associated with a character from an image (or video).

That is, the present disclosure relates to a method and apparatus for extracting/identifying the role of one or more characters appearing in a video by extracting sequence features of multi-modal data of the video. By various embodiments of the present disclosure, not only the name, number of appearances, or/and time of appearance of the character appearing in the video, but also the high-level context centered on the character can be extracted.

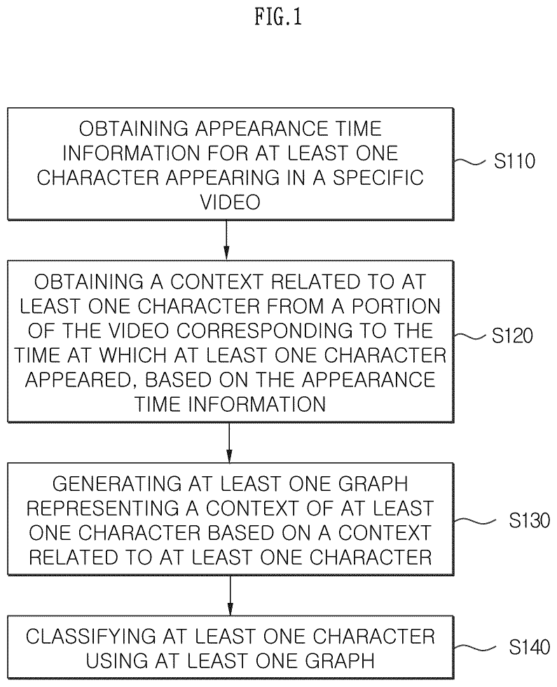

FIG. 1 is a flowchart illustrating a method for extracting context associated with a character from an image (or video) according to one embodiment of the present disclosure.

In FIG. 1, the device can be implemented as a smart phone, a desktop, a laptop, a tablet PC, a wearable device, etc., but is not limited thereto. The device for extracting context related to a character in an image (or video) described through FIG. 1 can be implemented as various types of computational/electronic devices.

The device may obtain appearance time information for at least one character appearing in a specific video (or image) (S110).

As an example of the present disclosure, assume that a specific video is input/selected on the device. The device may identify i) the start time and end time of appearance and ii) the number of appearances of at least one character in the specific video. In other words, the device may count/identify the unit time information and the number of appearances of each character appearing in the specific video (or image).

The device may obtain a list of appearance times consisting of at least one character-specific appearance start time and appearance end time, as the appearance time information.

The device may obtain a context related to at least one character from a portion of the video corresponding to the time at which at least one character appeared, based on the appearance time information (S120).

Specifically, the device may identify a time at which at least one character appears within a specific video using appearance time information. And, the device may obtain a context related to at least one character from a portion of the video corresponding to the time at which at least one character appears.

Here, the context related to the first character among at least one character may include: i) information about the interaction of the first character with other objects with which the first character interacts, ii) the proportion of the first character in the specific video portion, iii) the similarity between the visual-auditory features of the first character and the visual-auditory features of the other character, and iv) the similarity between the behavioral features of the first character and the behavioral features of the other character.

Specifically, the device may generate/obtain a two-dimensional tensor representing the similarity between the visual-auditory features of the first character and the visual-auditory features of the other character. The device may generate/obtain three-dimensional tensor data representing the visual-auditory-behavioral features between the first character and the other character based on the similarity between the visual-auditory features of the first character and the visual-auditory features of the other character and the similarity between the behavioral features of the first character and the behavioral features of the other character.

Here, based on the appearance time information, the device may generate a three-dimensional tensor representing visual-auditory-behavioral features between the first character and other characters for each time the first character appears.

The device may generate at least one graph representing a context of at least one character based on a context related to at least one character (S130).

For example, a graph of the first character among the at least one character may include nodes corresponding to the first character, other objects, and other characters, respectively.

Based on the context related to the first character, nodes corresponding to the first character, other objects, and other characters may be connected, respectively. That is, if the first character interacts with other objects and other characters within a specific video, nodes corresponding to the first character, other objects, and other characters may be connected to each other.

Additionally, nodes representing visual features, audio features, and behavioral features of the first character may be connected to nodes corresponding to the first character.

The device may classify at least one character using at least one graph (S140).

The device may classify each of the at least one character into a specific category by performing character node clustering on at least one graph.

Here, the specific category may include at least one of a category of a specific character of a specific video, a category of a main character supporting the specific character of a specific video, a category of characters linking characters appearing in a specific video, or a category of characters having unique features in a specific video.

As an example of the present disclosure, based on an input query (e.g., a natural language-based query, etc.) for a first character, the device may identify a graph of the first character among graphs of at least one character.

The device may identify at least one node in the graph of the first character that is associated with the query (e.g., a node corresponding to another character and/or another object).

The device may output an answer to the query based on the at least one node.

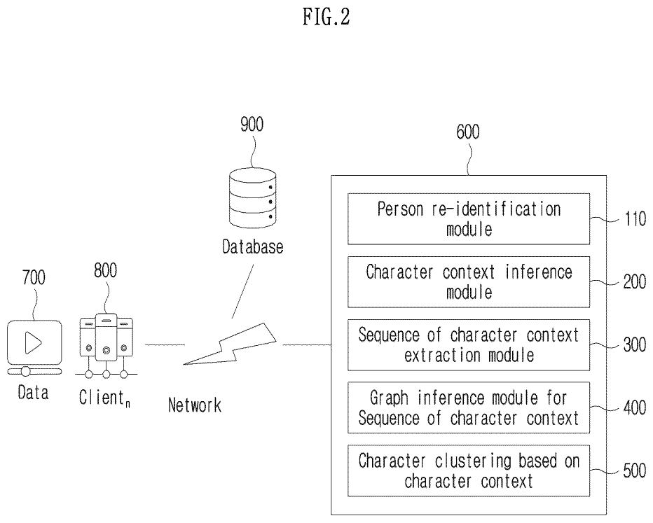

FIG. 2 is a diagram illustrating a character-based(or centered) context extraction system and device according to one embodiment of the present disclosure.

As illustrated in FIG. 2, the character-based context extraction system (600) may include one or more modules. A client (or a device used by the client) (800) may possess or have authority over the character-based context extraction system (600) and the target video (700).

For example, a character-based context extraction system (600) may include a person (or character) identification module (or, person (or character) re-identification module) (110), a character context inference module (200), a sequence of character context extraction module (300), a graph inference module for sequence of character context module (400), and a significance analysis for character context module (500).

The person identification module (110) is a module that identifies the identical character (or person) in a target image and may store information about the identified identical character in a database.

Specifically, the person identification module (110) may recognize that a character (or person) who first appeared in the video has reappeared. Accordingly, the person identification module (110) may extract appearance time information (or appearance time information) of multiple people (or characters) appearing in the video (e.g., the number of appearances and/or appearance times of the characters).

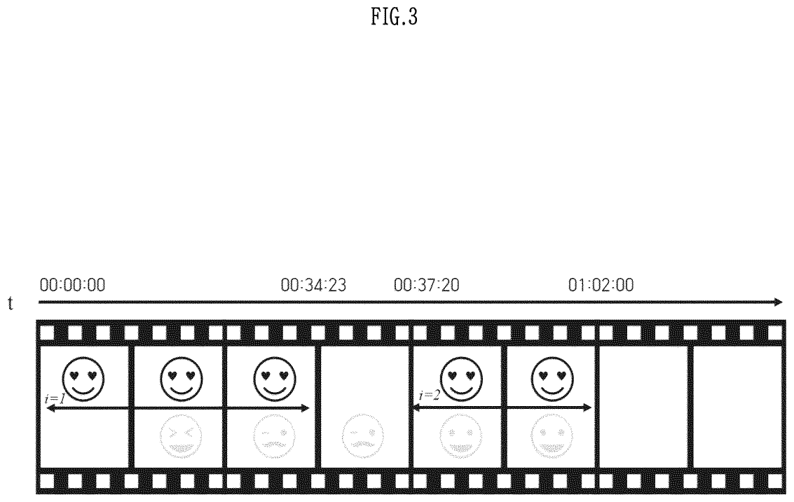

For example, as shown in FIG. 3, assume that person 1 appears in the video. The person identification module (110) may recognize that person 1 first appeared at [00:00:00] and identify that person 1 appeared until [00:34:23]. In addition, the person identification module (110) may recognize that person 1 appeared for the second time at [00:37:20] and identify that person 1 appeared until [01:02:00].

The person identification module (110) may extract that the total number of appearances of person 1 is 2, and may configure appearance time information in the form of [appearance start time, appearance end time].

And, the person identification module (110) may configure a list in the form of [appearance start time, appearance end time], and the order in which each person appears may be defined as i. For example, person identification module (110) may configure a list in the form of “person 1: [[00:00:00, 00:34:23], [00:37:20, 01:02:00]]”.

The character context inference module (200) may extract content for each corresponding part of the video using information about the time at which the character appeared.

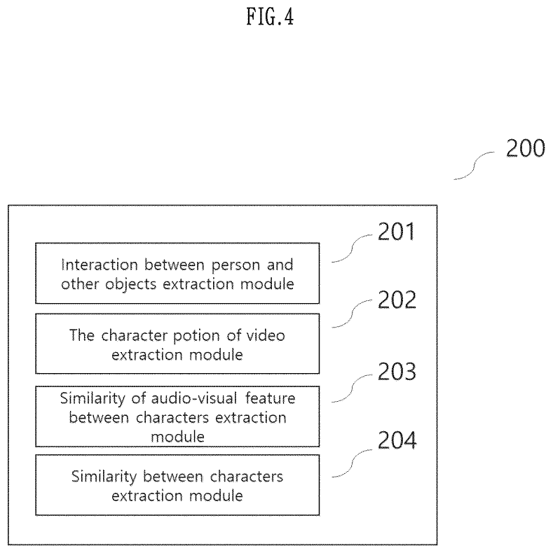

As an example of the present disclosure, as illustrated in FIG. 4, the character context inference module (200) may include a first module (201) for extracting interactions between a character and other objects, a second module (202) for extracting a character part from an image, a third module (203) for extracting similarity of audio-visual features between characters, and a fourth module (204) for extracting similarity between characters.

The first module (201) may extract the context of each character and object (e.g., objects and other characters) appearing in the video through inference using a scene graph extraction model.

The second module (202) may calculate the proportion of a character in an image by using the length of time that a character recognized in an image appears and the proportion of the image that the character occupies on the screen.

For example, the second module (202) may calculate the proportion (C^{potion}) of a character in an image using mathematical Equation 1.

$${C}^{potion} = α \sum Δ {t}_{ci} + β \sum {w}_{ci} , α + β = 1 \qquad [ Equation 1 ]$$

In Equation 1, i represents a sequence in which a character appears, Δ_{ci} represents the retention time of the character in sequence i, and w_{ci} represents the area occupied by the character on the screen in sequence i.

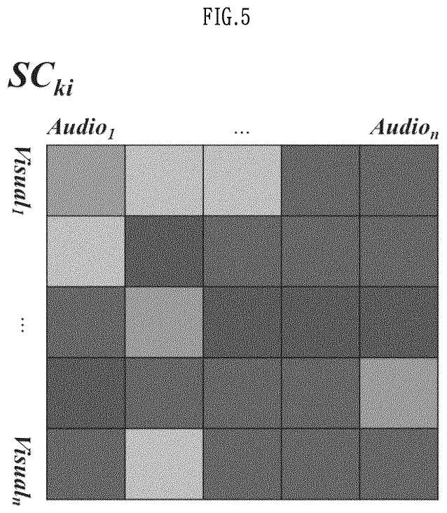

As illustrated in FIG. 5, the third module (203) may extract a similarity matrix by extracting audio-visual features of a character appearing in an image.

Here, SCₖᵢ represents the audio-visual feature similarity matrix of character k in the i^{th} appearance with other characters, and n represents other characters except k(k⊂n).

In the same way as the similarity was extracted from the audio-visual features, the fourth module (204) may extract activity features and extract a similarity vector to generate a three-dimensional tensor for audio-visual-behavior similarity.

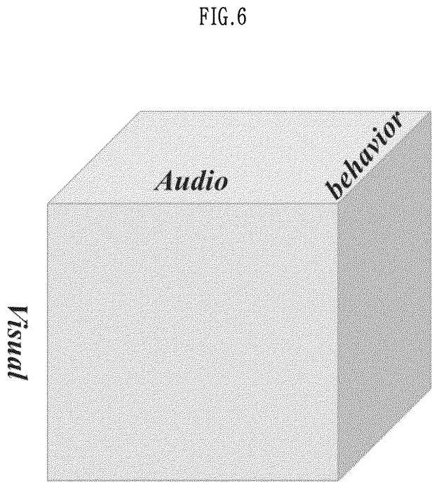

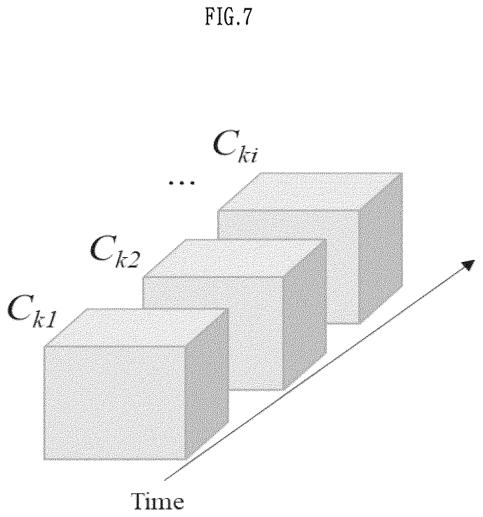

As an example of the present disclosure, FIG. 6 illustrates an audio-visual-action feature similarity tensor between a person k and another person n generated by the fourth module (204). And FIG. 7 illustrates a set of (audio-visual-action) similarity tensors for a person k in a sequence i.

The sequence of character context extraction module (300) may extract the character context sequence from an image using the character appearance time information extracted from the person identification module (110).

The graph inference module for sequence of character context (400) may generate a graph using character and character context sequences according to the time flow of the image.

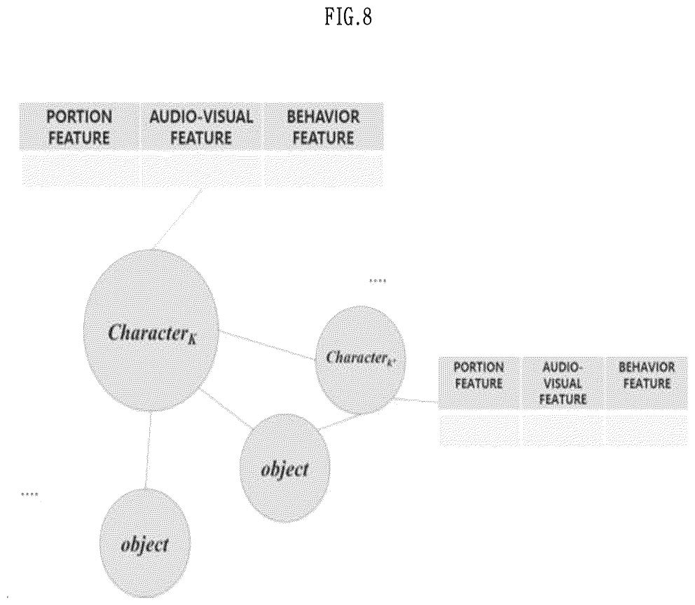

Specifically, as illustrated in FIG. 8, the graph inference module for sequence of character context (400) may generate a context sequence related to person k. FIG. 8 illustrates a graph of person k and other objects (e.g., other characters (or people), etc.) at time t.

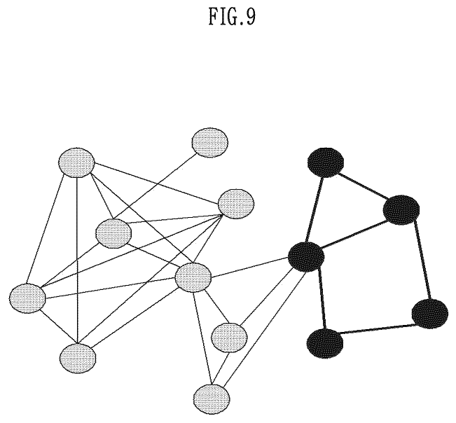

As illustrated in FIG. 9, the graph inference module for sequence of character context (400) may extract multiple subgraphs having unique characteristics through analysis of the generated graph.

The context-based character classification (or clustering) module (500) may perform character node clustering for character nodes based on a graph generated through the person (or character) identification module (or character re-identification module) (100), the character context inference module (200), the sequence of character context extraction module (300), and the graph inference module for sequence of character context (400).

As described above, a character node may be extracted through the person identification module (100), and features (e.g., feature tensors) of a character node may be extracted through the character context inference module (200). A sequence of a graph may be extracted based on the character node and the features of the character node by the sequence of character context extraction module (300). A meaningful context (i.e., a subgraph) of a graph sequence constructed by the graph inference module for sequence of character context (400) may be extracted.

In order to perform analysis of multiple modules included in the character-based (or centered) context extraction system (600), the above-described graphs may be generated for multiple images. The generated graphs may have connectivity centered on the same character (e.g., actor).

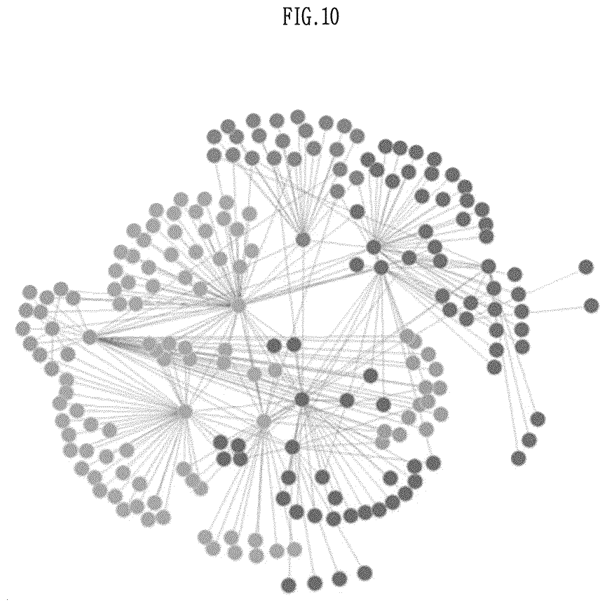

As an example of the present disclosure, it is assumed that the above-described graph for a plurality of images is constructed. As illustrated in FIG. 10, a node clustering method utilized in social network analysis may be applied.

When node clustering is applied, based on the application results, it may be identified whether the character pointed to by a specific node is i) the specific character of the video, ii) a character with a strong personality with features very different from other characters, iii) a main character who assists (or supports) the specific character, or iv) a character who acts as a bridge between characters.

Additionally, based on the sub-graph to which the character belongs, key narrative information to which the character belongs may be extracted.

According to various embodiments of the present disclosure, a service may be provided that can perform image search through a character-centered context, thereby enabling expanded search focused on consumer tendencies.

Additionally, by utilizing the collected user search history, content recommendations and searches that take into account the user's tastes may be made based on character-centered (or character-based) contextual similarity.

Through various embodiments of the present disclosure, limitations of existing video search services can be overcome, and problems in customer-tailored video recommendation services can be solved.

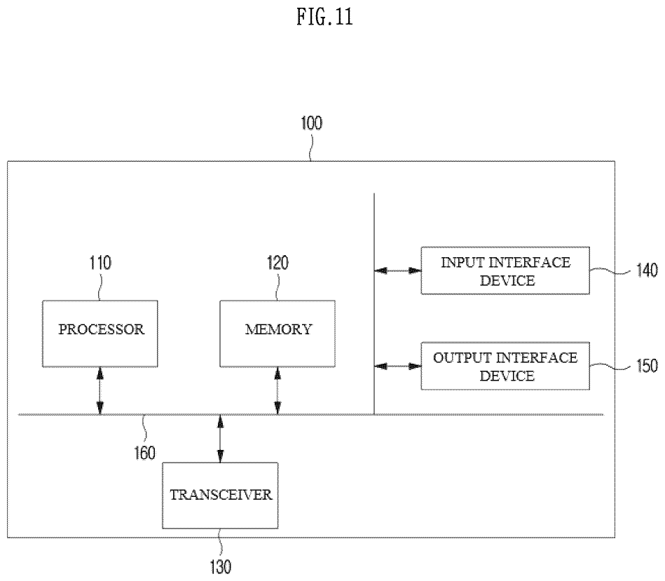

FIG. 11 is a block diagram illustrating a device according to an embodiment of the present disclosure.

The device (100) illustrated in FIG. 11 may collectively refer to a device that acquires and utilizes a context associated with a character in an image (or video).

The device 100 may include at least one of a processor 110, a memory 120, a transceiver 130, an input interface device 140, and an output interface device 150. Each component is connected by a common bus 160 and can communicate with each other. Additionally, each component may be connected through an individual interface or individual bus centered on the processor 110, rather than through the common bus 160.

The processor 110 may be implemented in various types such as an application processor (AP), central processing unit (CPU), graphics processing unit (GPU), etc., and may be any semiconductor device that executes instructions stored in the memory 120. The processor 110 may execute program commands stored in the memory 120. The processor (110) may obtain a context related to a character in an image (or video) based on the above-described FIGS. 1 to 10.

And/or, the processor (110) may store program instructions for implementing at least one function for one or more modules in the memory (120) to control the operations described based on FIGS. 1 to 10 to be performed. That is, each operation and/or function according to FIGS. 1 to 10 may be executed by one or more processors (110).

One or more modules controlled by the processor (110) have been described with reference to FIG. 4, etc., so redundant descriptions will be omitted.

Memory 120 may include various types of volatile or non-volatile storage media. For example, the memory 120 may include read-only memory (ROM) and random access memory (RAM). In an embodiment of the present disclosure, the memory 120 may be located inside or outside the processor 110, and the memory 120 may be connected to the processor 110 through various known means.

For example, the memory (120) may store at least one character-specific appearance time information and/or context extracted from a specific image (or video).

The transceiver (130) may perform a function of transmitting and receiving data processed/to be processed by the processor (110) with an external device and/or an external system.

For example, the transceiver (130) may be utilized for data exchange with other terminal devices, etc.

The input interface device (140) may be configured to provide data to the processor (110).

The output interface device (150) may be configured to output data from the processor (110).

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that the present disclosure include all other substitutions, modifications and variations falling within the scope of the following claims.

What is claimed is:

1. A method for obtaining context associated with a character in a video performed by a device, the method comprising:
obtaining appearance time information for at least one character appearing in a specific video;
obtaining a context related to at least one character from a video portion corresponding to a time at which the at least one character appeared based on the appearance time information;
generating at least one graph representing a context of the at least one character based on the context related to the at least one character; and
classifying the at least one character using the at least one graph.

2. The method of claim 1, wherein the obtaining the appearance time information includes:
identifying i) an appearance start time and an appearance end time and ii) a number of appearances of the at least one character in the specific video; and
obtaining an appearance time list composed of the appearance start time and the appearance end time of the at least one character as the appearance time information.

3. The method of claim 1, wherein:
a context related to a first character among the at least one characters includes:
i) information about an interaction of the first character with other objects with which the first character interacts;
ii) a proportion of the first character in the specific video portion;
iii) a similarity between visual-auditory features of the first character and visual-auditory features of other characters; and
iv) a similarity between behavioral features of the first character and behavioral features of the other characters.

4. The method of claim 3, wherein:
based on the similarity between the visual-auditory features of the first character and the visual-auditory features of the other characters and the similarity between the behavioral features of the first character and the behavioral features of the other characters, a three-dimensional tensor representing visual-auditory-behavioral features between the first character and the other characters is generated.

5. The method of claim 4, wherein:
based on the appearance time information, a three-dimensional tensor is generated that represents the visual-auditory-behavioral features between the first character and the other characters at each time the first character appears.

6. The method of claim 5, wherein:
a graph of the first character includes nodes corresponding to the first character, the other objects, and the other characters, respectively,
based on the context related to a first character among the at least one character, nodes corresponding to each of the first character, the other objects and the other character are connected, and
nodes representing a visual feature, audio feature, and behavioral feature of the first character are connected to the nodes corresponding to the first character.

7. The method of claim 6, wherein:
the classifying includes classifying each of the at least one character into a specific category by performing character node clustering on the at least one graph.

8. The method of claim 7, wherein:
the specific category includes at least one of a specific character category of the specific video, a main character category that assists the specific character of the specific video, a character category that connects characters appearing in the specific video, or a character category that has unique features in the specific video.

9. The method of claim 8, further comprising:
identifying a graph of the first character based on a query input for the first character;
identifying at least one node associated with the query among the graph of the first character; and
outputting an answer to the query based on the at least one node.

10. A device that obtains context related to a character in a video, the device comprising:
at least one memory; and
at least one processor,
wherein the at least one processor is configured to:
obtain appearance time information for at least one character appearing in a specific video;
obtain a context related to at least one character from a video portion corresponding to a time at which the at least one character appeared based on the appearance time information;
generate at least one graph representing a context of the at least one character based on the context related to the at least one character; and
classify the at least one character using the at least one graph.

11. The device of claim 10, wherein:
the at least one processor is configured to:
identify i) an appearance start time and an appearance end time and ii) a number of appearances of the at least one character in the specific video; and
obtain an appearance time list composed of the appearance start time and the appearance end time of the at least one character as the appearance time information.

12. The device of claim 10, wherein:
a context related to a first character among the at least one characters includes:
i) information about an interaction of the first character with other objects with which the first character interacts;
ii) a proportion of the first character in the specific video portion;
iii) a similarity between visual-auditory features of the first character and visual-auditory features of other characters; and
iv) a similarity between behavioral features of the first character and behavioral features of the other characters.

13. The device of claim 12, wherein:
based on the similarity between the visual-auditory features of the first character and the visual-auditory features of the other characters and the similarity between the behavioral features of the first character and the behavioral features of the other characters, a three-dimensional tensor representing visual-auditory-behavioral features between the first character and the other characters is generated.

14. The device of claim 13, wherein:
based on the appearance time information, a three-dimensional tensor is generated that represents the visual-auditory-behavioral features between the first character and the other characters at each time the first character appears.

15. The device of claim 14, wherein:
a graph of the first character includes nodes corresponding to the first character, the other objects, and the other characters, respectively,
based on the context related to a first character among the at least one character, nodes corresponding to each of the first character, the other objects and the other character are connected, and
nodes representing a visual feature, audio feature, and behavioral feature of the first character are connected to the nodes corresponding to the first character.

16. The device of claim 15, wherein:
the at least one processor is configured to:
classify each of the at least one character into a specific category by performing character node clustering on the at least one graph.

17. The device of claim 16, wherein:
the specific category includes at least one of a specific character category of the specific video, a main character category that assists the specific character of the specific video, a character category that connects characters appearing in the specific video, or a character category that has unique features in the specific video.

18. The device of claim 17, wherein:
the at least one processor is configured to:
identify a graph of the first character based on a query input for the first character;
identify at least one node associated with the query among the graph of the first character; and
output an answer to the query based on the at least one node.

19. At least one non-transitory computer readable medium storing at least one instruction,
based on the at least one instruction being executed by at least one processor, a device controls to:
obtain appearance time information for at least one character appearing in a specific video;
obtain a context related to at least one character from a video portion corresponding to a time at which the at least one character appeared based on the appearance time information;
generate at least one graph representing a context of the at least one character based on the context related to the at least one character; and
classify the at least one character using the at least one graph.
